(19) United States
(12) Patent Application Publication
(10) Pub. No.: US 2025/0342812 A1
(43) Pub. Date: Nov. 6, 2025

(54) MODIFYING PLAYBACK BASED ON AUDIO CONTENT IN ANOTHER ZONE

(71) Applicant: Sonos, Inc., Goleta, CA (US)

(72) Inventors: Shilpa Sarode, Cambridge, MA (US); Zach Buchman, Ojai, CA (US); Jennifer Morse, Seattle, WA (US); Katie Inglis, Marfa, TX (US); Ashley Conway, Austin, TX (US); Neil Griffiths, Boston, MA (US); Peter Dodds, Seattle, WA (US)

(21) Appl. No.: 19/199,214

(22) Filed: May 5, 2025

Related U.S. Application Data
(60) Provisional application No. 63/643,121, filed on May 6, 2024.

(51) Int. Cl. G10K 11/175; G06F 3/16; H04R 27/00

(52) U.S. Cl. CPC G10K 11/1752; G06F 3/165; H04R 27/00

(57) ABSTRACT

Systems and methods for modifying playback based on audio content in another zone are described. An example method includes playing back first audio content via a first zone of a media playback system according to a first parameter, and detecting playback of second audio content via a second zone of the media playback system according to a second parameter. Based on the second audio content and/or the second parameter, the first parameter can be adjusted. The first audio content is then played back via the first zone according to the first adjusted parameter.

### CROSS-REFERENCE TO RELATED APPLICATION

This application claims the benefit of priority to U.S. Patent Application No. 63/643,121, filed May 6, 2024, which is incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIGS. 1I through 1L show schematic diagrams of corresponding media playback system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 2D is a diagram of another example housing for a playback device.

FIG. 2E is a diagram of another example housing for a playback device.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D

FIG. 3F shows a schematic diagram of an example voice input.

FIGS. 4A-4D show schematic diagrams of a control device in various stages of operation in accordance with aspects of the disclosed technology.

FIG. 5 shows a front view of a control device.

FIG. 6 shows a message flow diagram of a media playback system.

FIG. 7 shows a schematic view of an environment having a media playback system configured in accordance with aspects of the disclosed technology.

FIG. 8 is a flow chart of an example method in accordance with aspects of the disclosed technology.

FIG. 9 is a flow chart of an example method in accordance with aspects of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

There are many scenarios in which audio playback in one area of an environment can undesirably impact the acoustic experience of users in another environment or multiple other environments. For instance, when a parent is watching a movie in the living room, the audio may carry into a child's bedroom, interfering with the child's ability to fall asleep. In the case of promoting sleep, many parents rely on sleep masking to help soothe young children and help them fall asleep (and stay asleep). Without any other substantial audio output or other noises in the house, a first type of noise (e.g., pink noise) at a relatively low volume may be sufficient and desirable. However, when audio is played back at relatively high volumes via another zone (e.g., home theater), the sleep masking may not be adequate to prevent disturbing a child's (or other sleeper's) sleep.

The present technology can address these and other problems by temporarily modifying audio output in one playback zone based at least in part on audio content in another playback zone. For instance, if a playback device in a child's bedroom is playing back masking noise, when playback in the living room that exceeds a threshold is detected, the masking noise played back in the child's bedroom can be temporarily adjusted, for instance selecting a different type of noise (e.g., brown noise vs. pink noise), raising the volume of playback, or making any other suitable adjustment that will increase the masking effect of the audio. Such modifications can be reverted once conditions have changed (e.g., playback of the audio content in the living room has ceased or has fallen below a predetermined threshold of volume level, sound-propagation, or other such parameter).

In a related approach, if a first zone such as a child's bedroom is designated as entering a sleep mode (or quiet mode, sound-isolated mode, focus mode, or other mode or state in which reduced audio interference is desired), then audio content in other zones may be modified to avoid sound propagating into the first zone. For example, when the first zone is designated as entering sleep mode, playback of home theatre content in a second zone (e.g., the living room) may be modified in a manner that reduces the propagation of sound into the first zone. Such modifications can involve lowering the volume (either uniformly or dynamically, such as compressing the dynamic range), adjusting the equalization settings to reduce output of certain frequencies (e.g., reducing output of low-frequency content, which tends to propagate further than high-frequency content), or any other suitable adjustment.

Accordingly, by selectively modifying playback to promote a user's perception of acoustic isolation from one zone to the next, the user experience can be improved. This can be particularly beneficial in the case of sleep modes, in which it is highly undesirable for audio from one room to interfere with a user's sleep in another room.

In various examples, these modifications can be made in response to determinations that sound from one zone has propagated into or will likely propagate into a second zone, and/or that the sound from one zone is likely to cause undesirable outcomes in a second zone. Such determinations can be made using sensor data (e.g., microphones in a first zone detect audio output from the second zone), by using predictive models (e.g., a sound-propagation model can be constructed to estimate resulting sound levels in various zones based on playback of audio content from a given source), by using schedule-based rules or zone activity heuristics (e.g., after a threshold time (e.g., 8 pm), and based on recent playback (e.g., playback of lullabies in the Nursery zone has recently concluded) indicates that high-volume audio from a first zone may cause undesirable outcomes in the Nursery zone), by a combination thereof, or by using other modalities.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves. For example, one of ordinary skill in the art will recognize that various actions described as being performed by a single actor may be performed by a group of actors and vice versa.

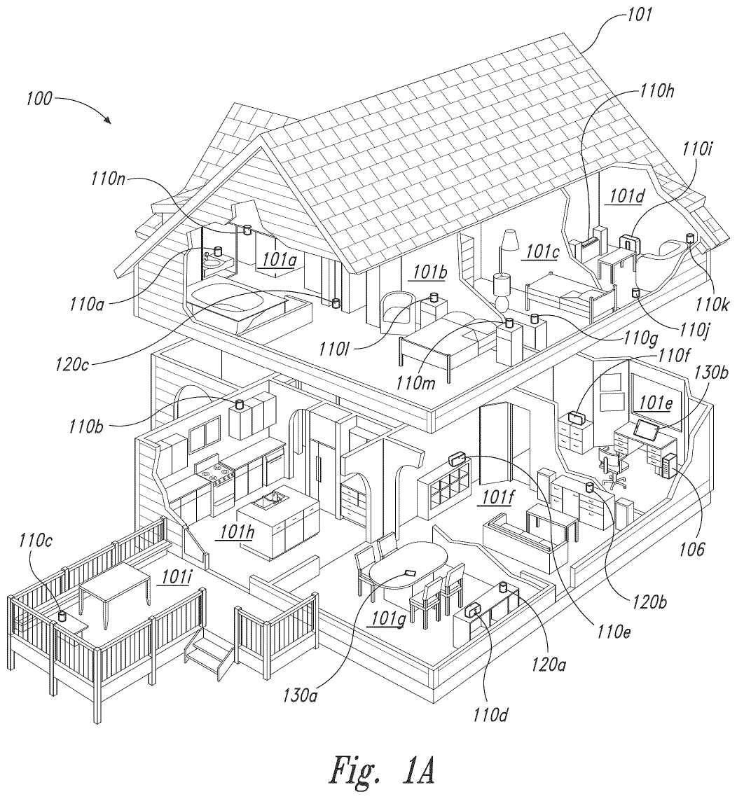

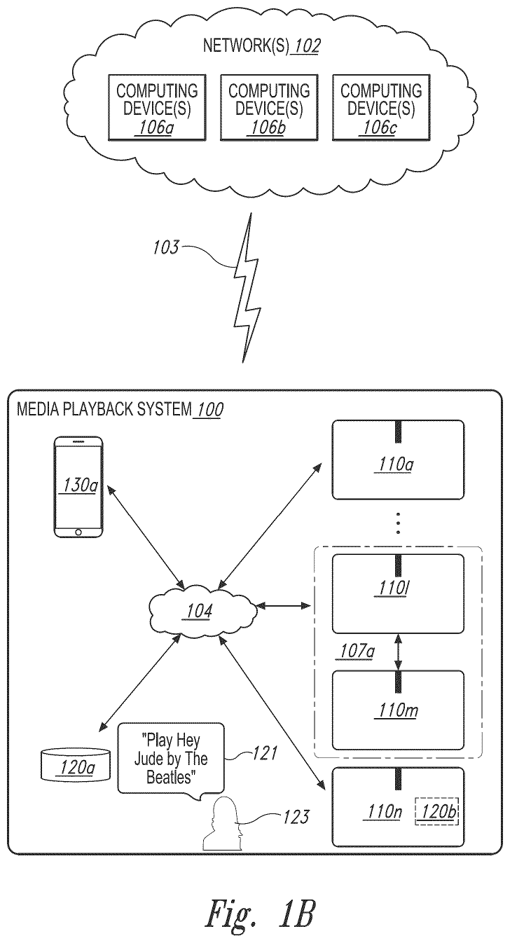

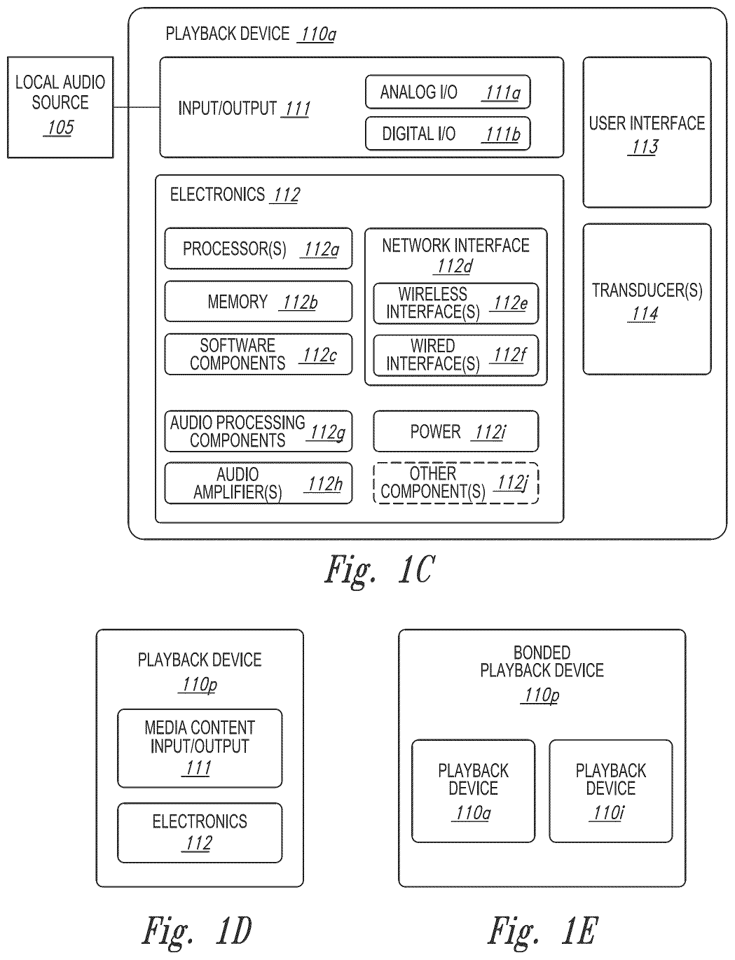

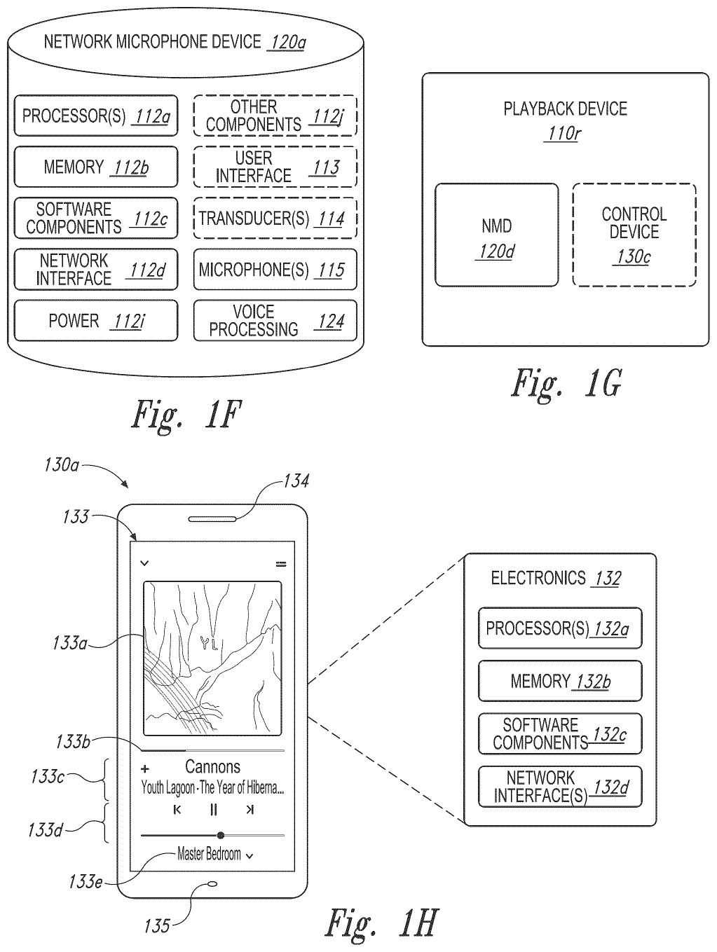

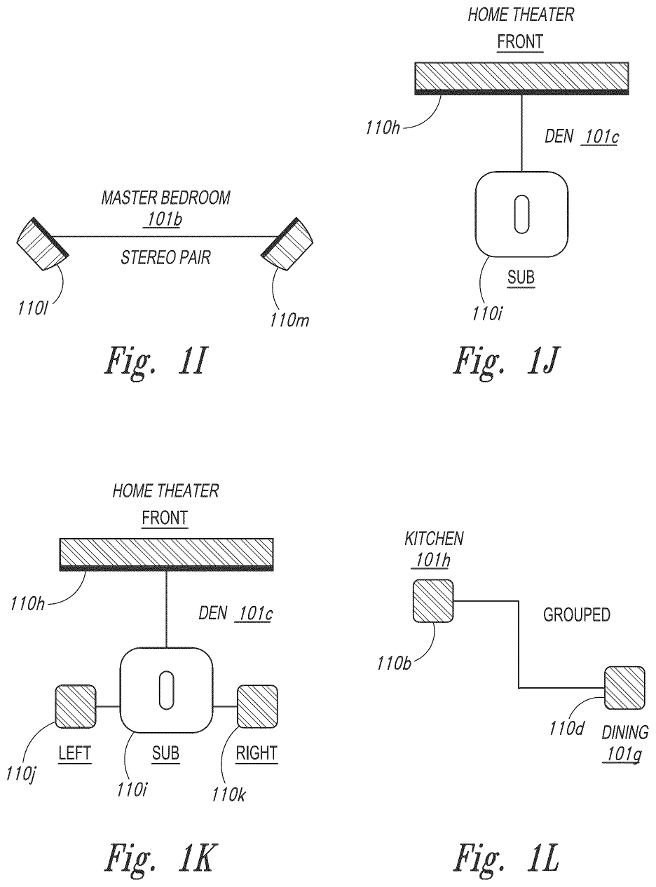

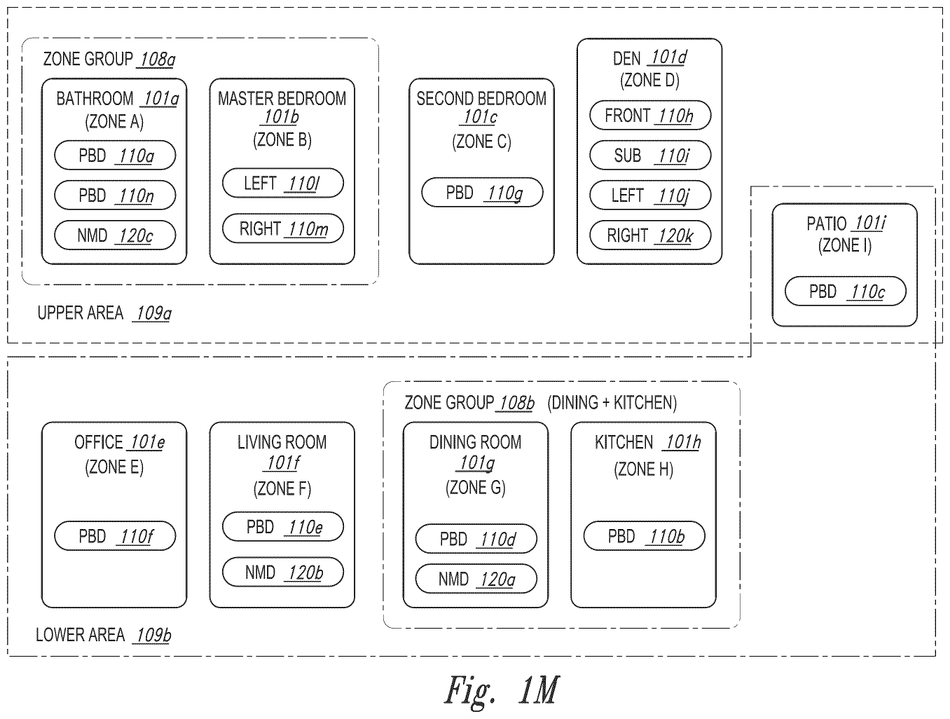

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 1101 and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

To facilitate synchronous playback, the playback device(s) described herein may, in some embodiments, be configurable to operate in (and/or switch between) different modes such as an audio playback group coordinator mode and/or an audio playback group member mode. While operating in the audio playback group coordinator mode, the playback device may be configured to coordinate playback within the group by, for example, performing one or more of the following functions: (i) receiving audio content from an audio source, (ii) using a clock (e.g., a physical clock or a virtual clock) in the playback device to generate playback timing information for the audio content, (iii) transmitting portions of the audio content and playback timing for the portions of the audio content to at least one other playback device (e.g., at least one other playback device operating in an audio playback group member mode), (iv) transmitting timing information (e.g., generated using the clock to the at least one other playback device; and/or (v) playing back the audio content in synchrony with the at least one other playback device using the generated playback timing information and/or the clock. While operating in the audio playback group member mode, the playback device may be configured to perform one or more of the following functions: (i) receiving audio content and playback timing for the audio content from the at least one other device (e.g., a playback device operating in an audio playback group coordinator mode); (ii) receiving timing information from the at least one other device (e.g., a playback device operating in an audio playback group coordinator mode); and/or (iii) playing the audio content in synchrony with at least the other playback device using the playback timing for the audio content and/or the timing information.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN) (e.g., the Internet), one or more local area networks (LAN) (e.g., one or more WiFi networks), one or more personal area networks (PAN) (e.g., one or more BLUETOOTH networks, Z-WAVE networks, wireless Universal Serial Bus (USB) networks, ZIGBEE networks, and/or IRDA networks), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct or indirect connections, PANS, LANs, telecommunication networks, and/or other suitable communication links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through 1M.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

As described in more detail elsewhere herein, in some examples the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, the playback device 110a can be configured to transmit wireless power to one or more external devices. Additionally or alternatively, the playback device 110a can be configured to receive wireless power from one or more external transmitter devices, instead of or in addition to receiving power over a wired connection.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). The headphone may comprise a headband coupled to one or more earcups. For example, a first earcup may be coupled to a first end of the headband and a second earcup may be coupled to a second end of the headband that is opposite the first end. Each of the one or more earcups may house any portion of the electronic components in the playback device, such as one or more transducers. Further, the one or more of earcups may include a user interface for controlling operation of the headphone such as for controlling audio playback, volume level, and other functions. The user interface may include any of a variety of control elements such as buttons, knobs, dials, touch-sensitive surfaces, and/or touchscreens. An ear cushion may be coupled each of the one or more earcups. The ear cushions may provide a soft barrier between the head of a user and the one or more earcups to improve user comfort and/or provide acoustic isolation from the ambient (e.g., provide passive noise reduction (PNR)). Additionally (or alternatively), the headphone may employ active noise reduction (ANR) techniques to further reduce the user's perception of outside noise during playback.

In some instances, the headphone device may take the form of a hearable device. Hearable devices may include those headphone devices (e.g., ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.).

In some embodiments, one or more of the playback devices 110 comprise a docking station and/or an interface configured to interact with a docking station for personal mobile media playback devices. In certain embodiments, a playback device may be integral to another device or component such as a television, a projector, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

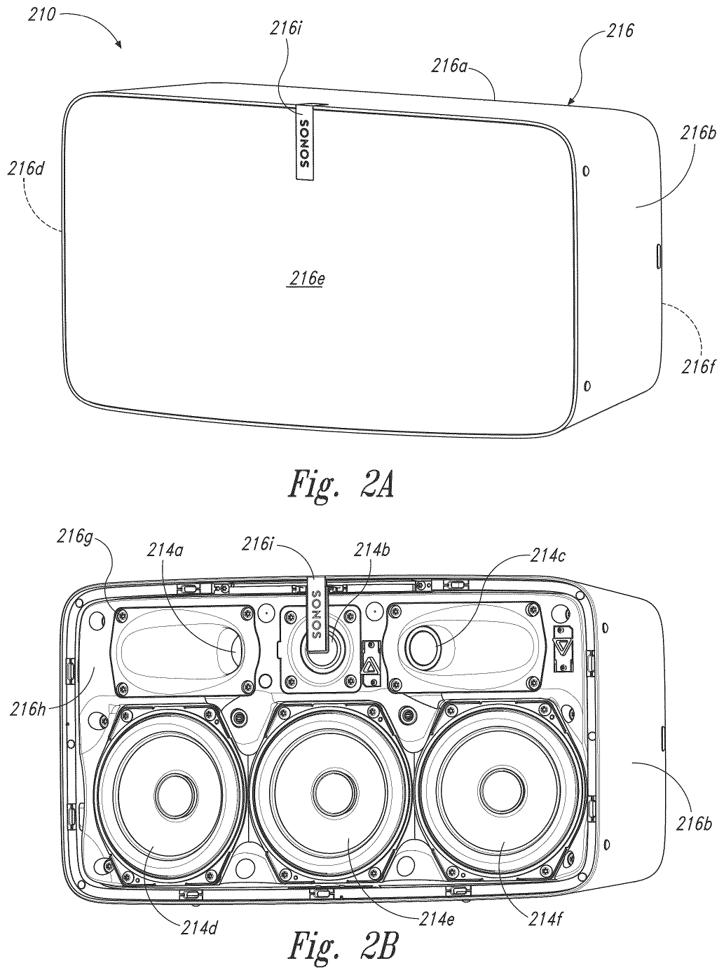

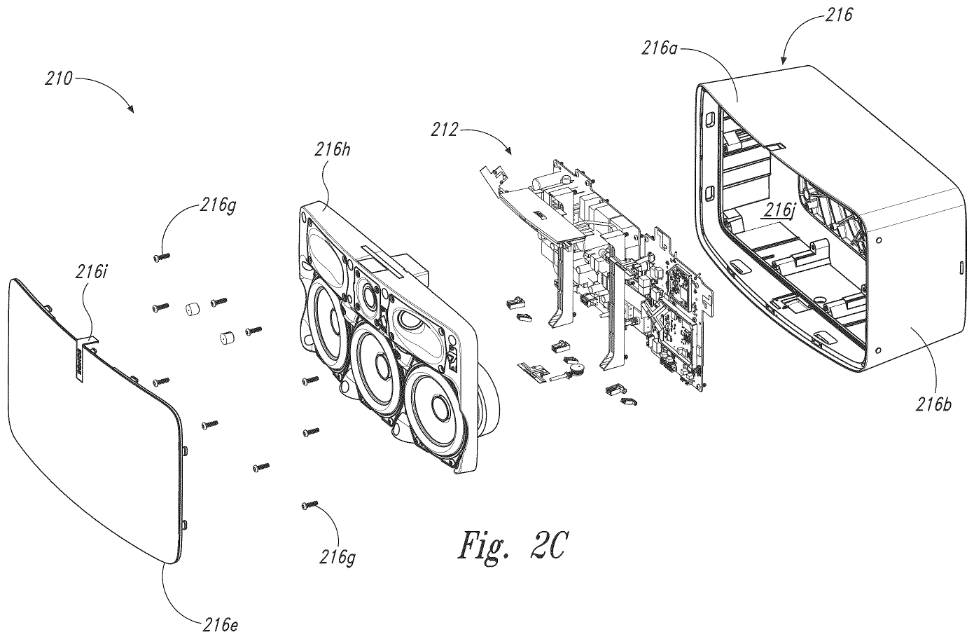

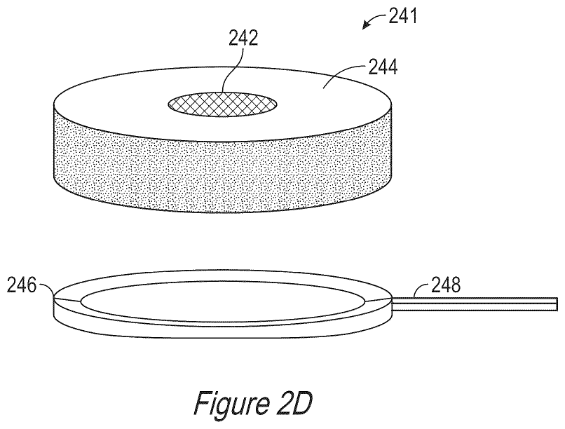

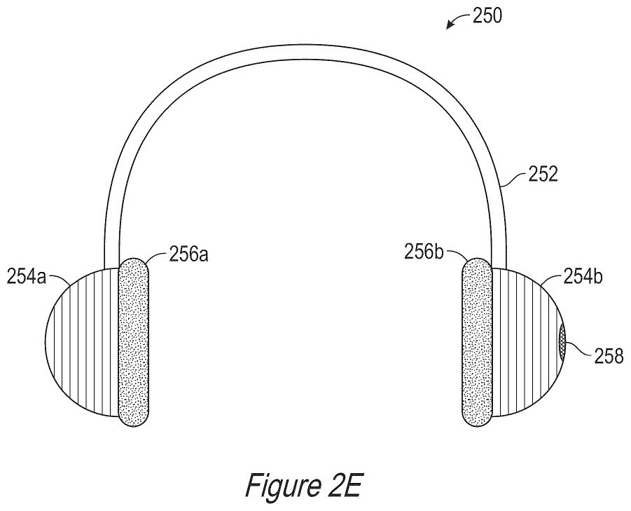

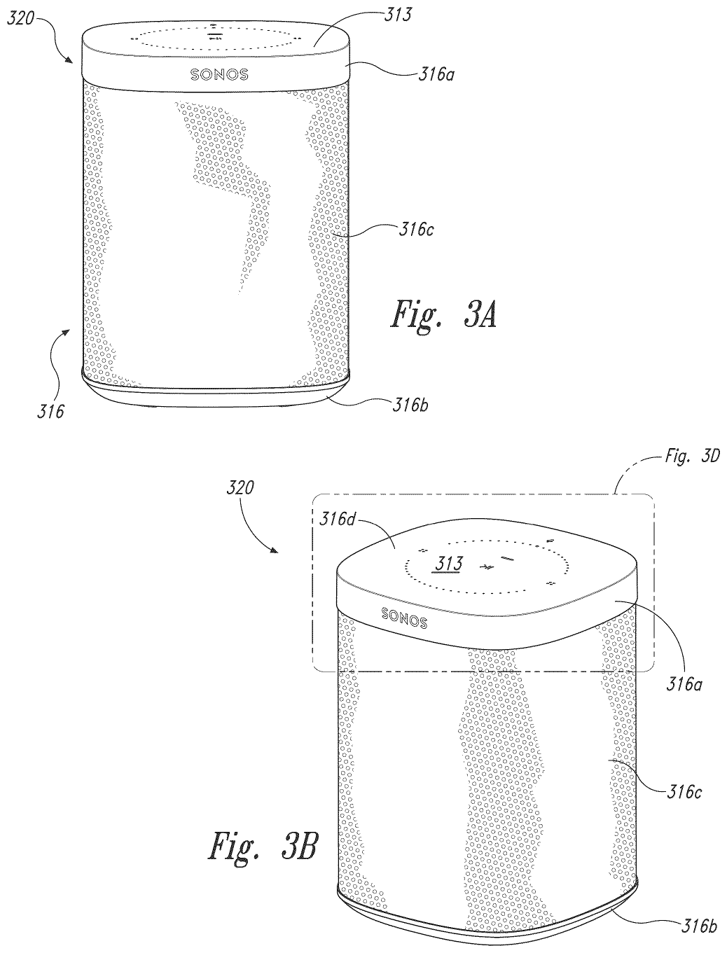

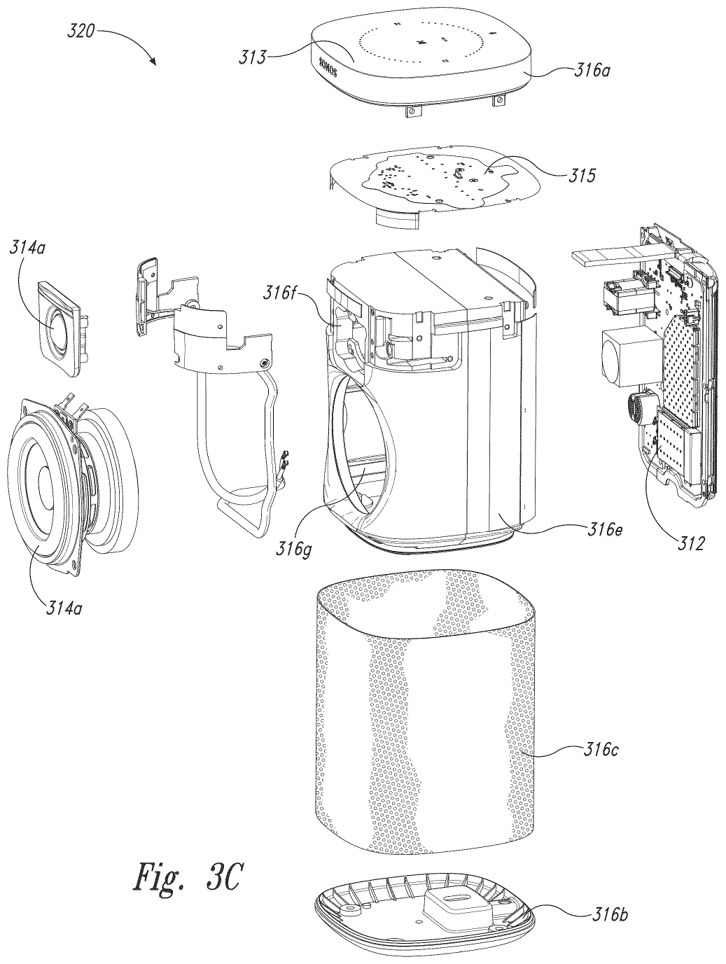

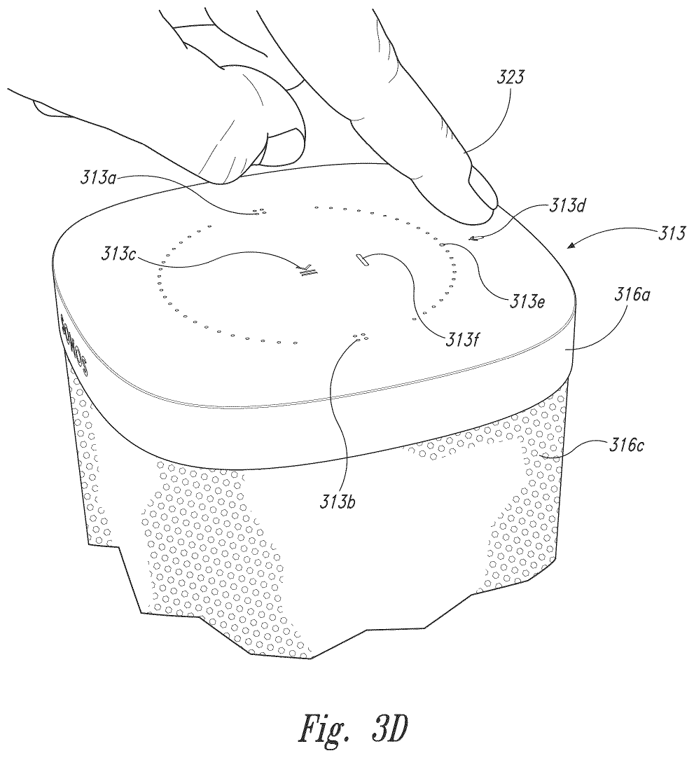

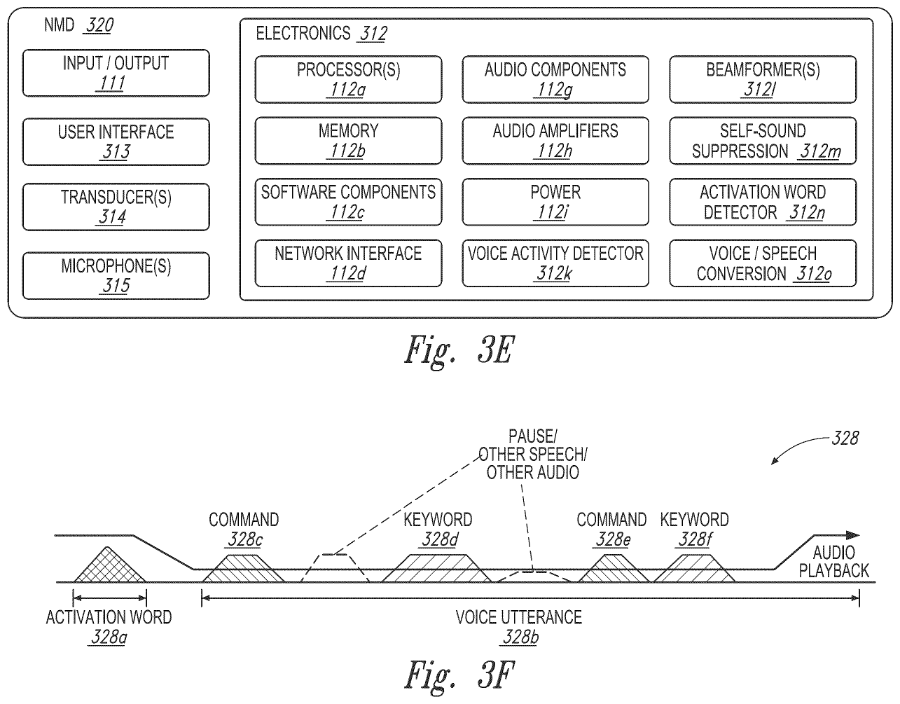

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 1101 and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, the power components 112i, and the microphones 115. As described elsewhere herein, the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, an NMD 120a can be configured to transmit wireless power to one or more external devices. Additionally or alternatively, the NMD 120a can be configured to receive wireless power from one or more external transmitter devices, in addition to or instead of receiving power over a wired connection.

The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

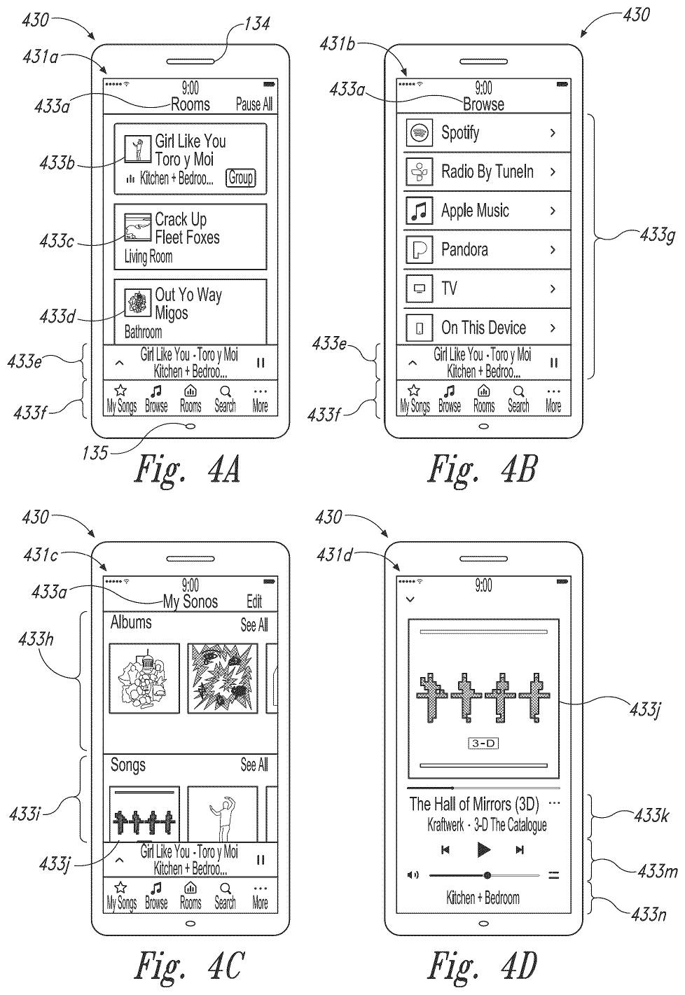

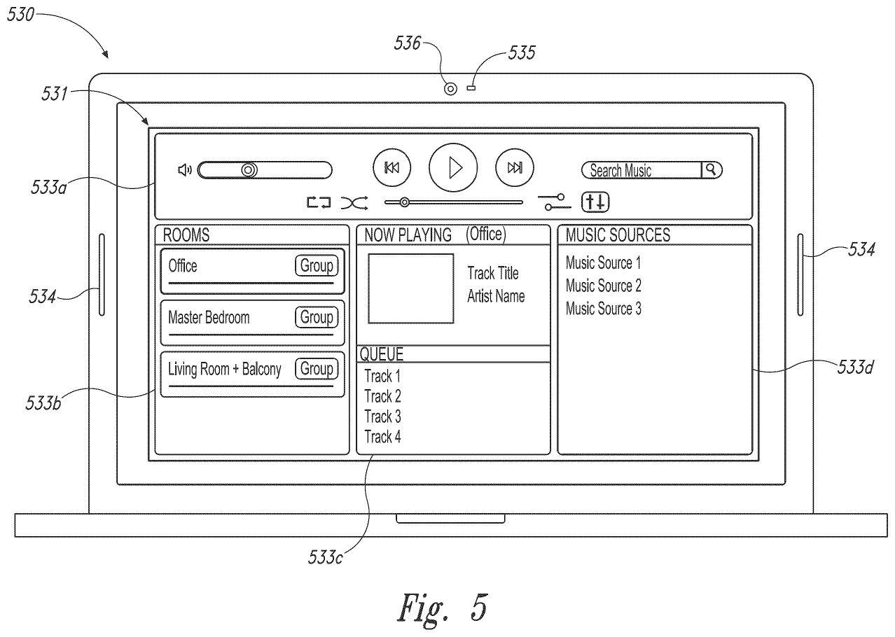

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1-I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 1101 (e.g., a left playback device) can be bonded to the playback device 1101 (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named M aster Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 1101 and 110m may be bonded so as to produce or enhance a stereo effect of audio content. In this example, the playback device 1101 may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and entitled “Room Association Based on Name,” and U.S. Pat. No. 8,483,853 filed Sep. 11, 2007, and entitled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

In some examples, the playback device 110 may be constructed as a portable playback device, such as an ultra-portable playback device, that comprises an internal power source. FIG. 2D shows an example housing 241 for such a portable playback device. As shown, the housing 241 of the portable playback device includes a user interface in the form of a control area 242 at a top portion 244 of the housing 241. The control area 242 may include a capacitive touch sensor for controlling audio playback, volume level, and other functions. The housing 241 of the portable playback device may be configured to engage with a dock 246 that is connected to an external power source via cable 248. The dock 246 may be configured to provide power to the portable playback device to recharge an internal battery. In some examples, the dock 246 may comprise a set of one or more conductive contacts (not shown) positioned on the top of the dock 246 that engage with conductive contacts on the bottom of the housing 241 (not shown). In other examples, the dock 246 may provide power from the cable 248 to the portable playback device without the use of conductive contacts. For example, the dock 246 may wirelessly charge the portable playback device via one or more inductive coils integrated into each of the dock 246 and the portable playback device.

In some examples, the playback device 110 may take the form of a wired and/or wireless headphone (e.g., an over-ear headphone, an on-ear headphone, or an in-ear headphone). For instance, FIG. 2E shows an example housing 250 for such an implementation of the playback device 110. As shown, the housing 250 includes a headband 252 that couples a first earpiece 254a to a second earpiece 254b. Each of the earpieces 254a and 254b may house any portion of the electronic components in the playback device, such as one or more speakers, and one or more microphones. In some instances, the housing 250 can enclose or carry one or more microphones. Further, one or more of the earpieces 254a and 254b may include a control area 258 for controlling audio playback, volume level, and other functions. The control area 258 may comprise any combination of the following: a capacitive touch sensor, a button, a switch, and a dial. As shown in FIG. 2D, the housing 250 may further include ear cushions 256a and 256b that are coupled to earpieces 254a and 254b, respectively. The ear cushions 256a and 256b may provide a soft barrier between the head of a user and the earpieces 254a and 254b, respectively, to improve user comfort and/or provide acoustic isolation from the ambient (e.g., passive noise reduction (PNR)). In some implementations, the wired and/or wireless headphones may be ultra-portable playback devices that are powered by an internal energy or power source and weigh less than fifty ounces.

In some examples, the playback device 110 may take the form of an in-ear headphone device. It should be appreciated that the playback device 110 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the playback device 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

While specific implementations of playback and network microphone devices have been described herein, there are numerous configurations of devices, including, but not limited to, those having no UI, microphones in different locations, multiple microphone arrays positioned in different arrangements, and/or any other configuration as appropriate to the requirements of a given application. For example, UIs and/or microphone arrays can be implemented in other playback devices and/or computing devices rather than those described herein. Further, although a specific example of playback device 110 is described with reference to MPS 100, one skilled in the art will recognize that playback devices as described herein can be used in a variety of different environments, including (but not limited to) environments with more and/or fewer elements, without departing from this invention. Likewise, MPSs as described herein can be used with various different playback devices.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes, or apertures 316d in the upper portion 316a allow sound to pass through to one or more microphones 315 (FIG. 3C) positioned within the housing 316. The one or more microphones 315 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and A EC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first-and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 3120 may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 557a can be a known activation word, such as “Alexa,” which is associated with AMAZON's ALEXA®. In other embodiments, however, the voice input 328 may not include an activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as a playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

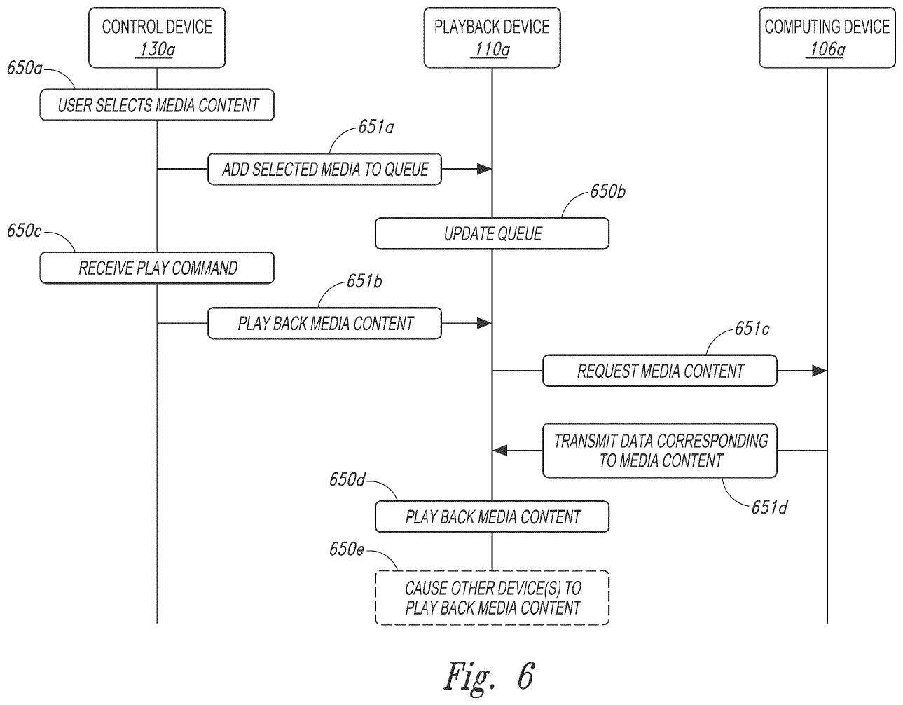

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

### IV. Example Systems and Methods for Modifying Audio Playback Based on Audio Content in Another Zone

As noted above, in some cases audio playback in one area of an environment can undesirably impact users in another area of the environment (or another environment). For instance, audio from out-loud listening in one bedroom may propagate into a user's home office, disrupting a user trying to focus on work. As another example, audio from a movie in a living room may carry into a child's bedroom when she's trying to sleep. In these and other such scenarios, the perceived acoustic isolation of one room or area from another can be increased by selectively modifying playback of one or more devices within the environment. As described in more detail below, this can involve modifying playback within the zone that is targeted for psychoacoustic isolation (e.g., adjusting a masking noise in a child's bedroom that is designated for sleep mode). Additionally or alternatively, this can involve modifying playback within the zone that is the source of the potentially interfering audio (e.g., lowering a maximum volume output from the home theater arrangement in the living room so as to reduce the acoustic impact within the child's bedroom).

In additional examples, a notification can be provided based on a determination that audio from out-loud listening in one zone may intrude on listeners in another zone. For instance, while a parent is watching a movie in a home theatre zone, based on a system determination that the audio may leak into a child's bedroom above a threshold level, a notification can be provided to the parent in the home theatre zone. This may prompt the parent to take manual steps to modify audio output (e.g., reducing volume, lowering bass content, transferring playback to other playback device(s) such as wearable headphones, initiating playback of masking audio in the child's bedroom, etc.) accordingly. Such prompts may be provided via an application on the control device, via a visual prompt displayed on an accompanying video display device, via audible output, or otherwise. In some implementations, such notifications can be based on microphone data from the other zone(s) (e.g., the child's bedroom), in which case audio such as a child crying may be detected, and an alert provided to the parent.

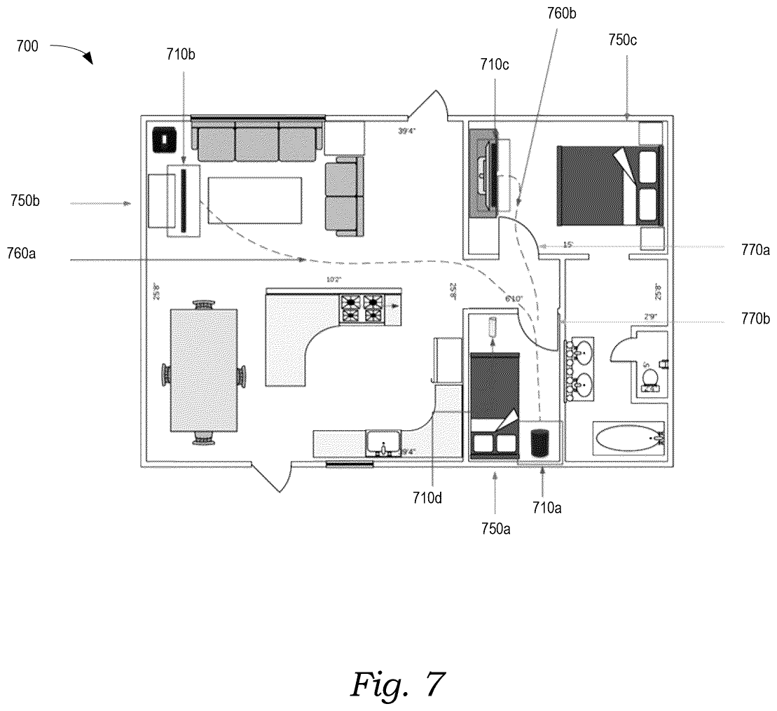

FIG. 7 illustrates an example media playback system 700 distributed within an environment, here a house. A plurality of audio playback devices 710 are distributed about the environment, including a first playback device 710a in a first zone 750a (e.g., a child's bedroom), a second playback device 710b in a second zone 750b (e.g., the living room), and a third playback device 710c in a third zone 750c (e.g., a master bedroom). A fourth playback device 710d can be portable and configured to move around the environment, optionally joining and leaving the various zones in different playback configurations.

In certain implementations, during playback of audio content, sound can propagate through the environment such as along various paths 760. For instance, a first representative path 760a may depict sound propagating from the second playback device 710b, such as a soundbar in a home theatre arrangement located in the second zone 750b, toward the first zone 750a. In some examples, the propagated sound can be detected by one or more microphones within the first zone 750a, which may include microphones integrated into the first playback device 710a, the portable fourth playback device 710d, a smartphone, tablet, or other device, or separate microphones positioned within the first zone 750a.

In various implementations, another representative sound path 760b may depict sound propagating from the third playback device 710c in the third zone 750c toward the first zone 750a. The second sound path 760b may traverse through a first door 770a and/or a second door 770b before reaching the first zone 750a, while the first sound path 760a may only pass through the second door 770b. In different examples, these doors 770 may be open or closed, and there may be additional doors, walls, windows, or other objects between an audio source and a given zone that affect sound propagation through the environment.

In a first example scenario, the first playback device 710a within the first zone 750a operates in a sleep mode that may involve outputting noise, such as brown, pink, or white noise, another form of masking noise, or a soundscape such as a generative audio soundscape. Additional details regarding generative audio soundscape generation and playback can be found in International Patent Application No. PCT/US2021/072454, filed Nov. 17, 2021, entitled “Playback of Generative Media Content,” which is hereby incorporated by reference in its entirety for all purposes. In various implementations, playback of audio content begins via the second playback device 710b, potentially in conjunction with a corresponding subwoofer and/or other satellite speakers, in the second zone 750b. Sound from the second zone 750b then propagates toward the first zone 750a via the first path 760a.

In some examples, when a particular threshold sound pressure level (SPL) (or sound power level) is reached or detected in the first zone 750a, which may depend on factors such as the volume levels of the first and second playback devices 710a, 710b, the distance of the first path 760a, and/or the state of the second door 770b, the volume level and/or type of content played back by the first playback device 710a is modified. In some scenarios, the threshold noise levels may further depend on other factors such as the ambient sound levels within a room or environment due to other sources (e.g. HVAC levels, traffic noise, etc.) Optionally, such a determination can be made not on a threshold SPL but on other parameters, such as threshold volume levels for different frequency ranges or other such suitable parameters.

In some examples, active sensing can be used to detect sound propagating from one zone to another. For instance, the sound level of audio arriving from outside the first zone 750a may be determined using the first playback device 710a, the fourth playback device 710d, or another device/sensor within the first zone 750a. One or more of the devices within the environment can include microphones used to detect audio within the different zones. As such, detected sound data can be collected in real-time to determine sound propagation from one zone to another.

In various implementations, a calibration process may be employed to determine a relationship between sound output from the second zone 750b and the sound level in the first zone 750a. Different calibrations may be used for scenarios where doors are open or closed. Additionally or alternatively, a sound-propagation model can be referenced to determine whether and to what extent sound from outside the first zone 750a has propagated or will propagate into the first zone 750a. In various implementations, such a sound-propagation model can be constructed within an environment to estimate or predict the sound levels (e.g., sound pressure levels or SPL) at a target location based on known audio outputs at one or more other locations within the environment. The sound-propagation model can rely on various types of information, including known or determined information about the playback devices in the environment, the playback status of those devices, and environmental information.

The information about the playback devices can include hardware specifications, such as the types of transducers (e.g., tweeters, mid-range drivers, woofers), their sizes, power ratings, and frequency response characteristics. Additionally, the locations of the playback devices within the environment can be used as inputs to the sound-propagation model. The location information may be determined using various techniques, such as manual input from a user, automated detection using built-in sensors (e.g., GPS, Wi-Fi triangulation), or audio mapping techniques that analyze the acoustic characteristics of the environment. Additional details regarding localization of playback devices and/or users within the environment can be found in (1) International Patent Application No. PCT/US2022/077185, filed Sep. 28, 2022, titled “Spatial Mapping of Media Playback System Components,” and (2) U.S. Pat. No. 11,444,375, issued Sep. 13, 2022, titled “Frequency Routing Based on Orientation,” each of which is hereby incorporated by reference in its entirety for all purposes.

The playback status of the devices can also be used as an input to the sound-propagation model. This can include information about what content is being played back, at what volume level, and via which specific playback devices. By knowing the audio output characteristics at the source locations, the sound-propagation model can more accurately predict the sound levels at the target location.

In addition to or instead of predicting objective sound levels at the target location, the sound-propagation model can determine the psychoacoustic effects of sound that reaches the target location. This may account for masking (or other audio) currently being played back at the target location, as well as other factors that may affect the psychoacoustic perception of audio in the target location. As such, in some instances relatively lower levels of sound reaching the target location may have a higher psychoacoustic impact in one scenario (e.g., when the target zone is silent) while relatively higher levels of sound reaching the target location may have a lower psychoacoustic impact in another scenario (e.g., ambient noise or current playback of audio content in the target zone render the intruding audio less perceptible).

Environmental information can also play a significant input for the construction of the sound-propagation model. This can include sensor data, such as temperature, humidity, and air pressure readings, which can affect how sound propagates through the environment. Additionally, audio mapping input or other characterizations of the acoustic environment can be used to refine the sound-propagation model. For example, the presence of sound-reflecting surfaces (e.g., walls, furniture) or sound-absorbing materials (e.g., curtains, carpets) can be factored into the model to more accurately predict how sound will propagate from the source locations to the target location. In some examples, wall construction characteristics can be factored into the model, either wall type (e.g., interior, exterior wall, fire-rated wall) and/or transmission characteristics (e.g., sound transmission class (STC) rating).

In some implementations, the sound-propagation model can be constructed using a combination of physical modeling techniques and machine learning algorithms. The physical modeling techniques can be based on the principles of acoustics and can take into account factors such as the distance between the source and target locations, the directionality of the sound sources, and the presence of any obstacles or reflective surfaces in the environment. Machine learning algorithms, such as neural networks or support vector machines, can be trained on a dataset of measured sound levels at various locations within the environment, along with the corresponding playback device information, playback status, and environmental information. Once trained, the machine learning model can be used to predict the sound levels at the target location based on new input data.

In some examples, the sound-propagation model comprises or produces output used as an input to a generative artificial intelligence model (GAI) that may generate novel synthetic content based on a variety of input parameters. In some cases, for example, the sound-propagation model may comprise data implemented as part of a distributed ledger such as a public, semi-public, or private blockchain. For instance, a sound-propagation model may be associated with a blockchain token such as a non-fungible token (NFT) and/or a smart contract executed in association with a decentralized autonomous organization (DAO) that corresponds to a particular household, condominium or apartment building, homeowner association, hospitality offering (e.g., hotel, short-term or long-term rental, campsite, etc.). Details and techniques associated with GAI and blockchain interactions can be found in International Patent Application No. PCT/US2023/066776, filed May 9, 2023, titled “Generating Digital Media Based on Blockchain Data,” which is hereby incorporated by reference in its entirety for all purposes.

The sound-propagation model can be periodically updated or refined based on new information or changes in the environment. For example, if a user rearranges the furniture in a room, and/or adds (or removes) sound-absorbing materials, the sound-propagation model can be updated to reflect these changes. Similarly, if the playback devices are moved to different locations or if new playback devices are added to the environment, the sound-propagation model can be updated to incorporate this new information.

By using a combination of physical modeling techniques, machine learning algorithms, and various types of input data, the sound-propagation model can provide accurate estimates or predictions of the sound levels at a target location within the environment. This information can be used by the media playback system to make intelligent decisions about how to adjust the audio output of the playback devices in order to optimize the acoustic experience for users in different zones or locations within the environment. Additional details regarding calibrating playback in various zones with respect to one another can be found in commonly owned U.S. Pat. No. 10,028,069, issued Jul. 17, 2018, titled “Immersive Audio in a Media Playback System,” which is hereby incorporated by reference in its entirety.

In certain implementations, the type of content being played back by the second playback device 710b may be detected using a controller application, a set-top box, a smart television, or other suitable approach. The content type may be used to determine an appropriate modification to the first audio output (e.g., type and extent of masking audio).

Based on the aforementioned factors, such as active sensing, calibration processes, a sound-propagation estimation or prediction, or determination of content being played back, the system 700 and/or the first playback device 710a can adjust the output of the first playback device 710a based on the sound level and/or frequency content of the output from the second playback device 710b. For example, the first playback device 710a may adjust its own volume or change the type of noise being played back in response to the output of the second playback device 710b.

In some implementations, the audio output of the second playback device 710b may be adjusted instead of, or in addition to, adjusting the output of the first playback device 710a. This may involve reducing the volume level or altering the frequency content (e.g., reducing bass) of the second playback device 710b. In certain examples, the sound levels of specific channels in multichannel audio content, such as rear surround or height channels, may be adjusted while other channels remain unaltered. Additionally or alternatively, certain subsets of transducers, such as up-firing or side-firing transducers, may be deactivated. This can be particularly useful if, based on the orientation of the second playback device 710b, certain directional transducers are primary contributors to the propagating sound that reaches the first zone 750a.

In various implementations, once the output of the second playback device 710b changes, such as a reduction in volume or a change in content type, the first playback device 710a may revert to its original settings. Such reversion can be implemented either immediately or gradually. In some instances, gradual reversion can beneficially reduce the risk of a jarring transition which risks disturbing the user.

With continued reference to FIG. 7, in another scenario, audio is played back via the third playback device 710c, either grouped with the second playback device 710b, playing separate content, or playing without content being played back by the second playback device 710b. Additionally, the first playback device 710a may be grouped with the fourth playback device 710d, which, as previously noted, can be a portable device. The doors 770a, 770b can be open or closed, either fully or partially, in different configurations.

In this scenario, audio may be adjusted in the first zone 750a by either the first playback device 710a or the fourth playback device 710d. Additionally or alternatively, audio may be adjusted in the third zone 750c by the third playback device 710c to lower the volume, reduce bass output, alter the directivity of output, or make other suitable adjustments.

In various implementations, zones can be designated to enter different modes, such as sleep mode, night mode, isolation mode, or focus mode, using a user interface on a controller device, voice input, or automated rules. These rules may be based on factors such as the time of day or the type of audio being played back (e.g., white noise). Additionally, the different modes can have adjustable intensity scales, such as a scale from 1 to 5, which determine how aggressively the system will mask audio from other zones.

In some examples, the system can be configured to detect and prioritize certain noises that should not be masked, such as alarms or other high-priority audio signals. This ensures that important audio information is not inadvertently obscured by the masking or isolation processes.

In various implementations, the calibration process for the system can involve a setup procedure similar to the Sonos Trueplay feature, in which a user walks around the environment with a controller device while the various playback devices communicate with each other. This process can incorporate techniques described in commonly owned U.S. patent application Ser. No. 18/695,533, filed Sep. 28, 2022, titled “Spatial Mapping of Media Playback System Components,” which is hereby incorporated by reference in its entirety.

In certain examples, the masking process can utilize look-ahead techniques to dynamically adjust the masking output based on the incoming audio content. Since the system 700 has access to the audio content in advance (even in the case of video-associated audio content when using a set-top box), it can proactively modify the masking output to optimize the psychoacoustic isolation between zones.

In some implementations, the masking process can be adapted based on the sleep cycle of individuals within the environment. By using data from sensors (e.g., wearable sensors such as smartwatches), the system 700 can determine the current stage of a person's sleep cycle and adjust the masking intensity accordingly. For example, during deeper stages of sleep, such as REM, the system may apply less aggressive masking compared to lighter stages of sleep.

In various examples, the system can impose limitations on which playback devices can be grouped together when certain modes, such as night, sleep, or isolation modes, are active. This prevents inadvertent disruptions in zones that are designated for rest or focus.

In some implementations, portable playback devices can automatically adjust their volume as they move between zones. For example, when a portable device enters or approaches a zone that is in sleep, night, or isolation mode, it can gradually lower its volume to avoid disturbing the audio environment in that zone.

In certain examples, the system can adjust the arraying or directivity of the audio output to minimize sound propagation in undesired directions. By strategically controlling the direction of the sound energy, the system can reduce the spillover of audio from one zone to another, enhancing the overall isolation between zones.

In various implementations, when a zone is in sleep mode, night mode, focus mode, or other such sound-isolating mode, the system 700 may apply additional changes beyond audio adjustments. For example, it may suppress non-essential notifications, advertisements, or software updates to minimize potential disruptions and maintain a more peaceful environment.

While some examples of the present technology are described in the context of residential environments, this technology can also be applied to commercial spaces, such as offices or restaurants, as well as multi-unit residential environments such as apartment buildings, townhomes, etc. In these and other settings, the system can be used to provide privacy and reduce distractions between adjacent areas, such as neighboring offices or dining sections within a restaurant, neighboring apartment units, etc. In some examples, a media playback system can determine that audio played back via a first location (e.g., a first office suite, a first apartment unit, etc.) may undesirably leak to a second location (e.g., sound pressure levels and/or perceived acoustic intrusion of audio in a second office suite, second apartment units, etc. may exceed a predetermined threshold. Based on this determination, playback may be automatically modified in one or both locations as described previously (e.g., reducing volume or EQ in the first location, initiating playback of masking audio in second location, etc.). Additionally or alternatively, a user prompt can be provided at one or both locations that allow a user to select such modifications (e.g., prompting a user in the first location to turn down volume, transfer playback to a wearable playback device, etc., or prompting a user in the second location to initiate playback of masking audio content).

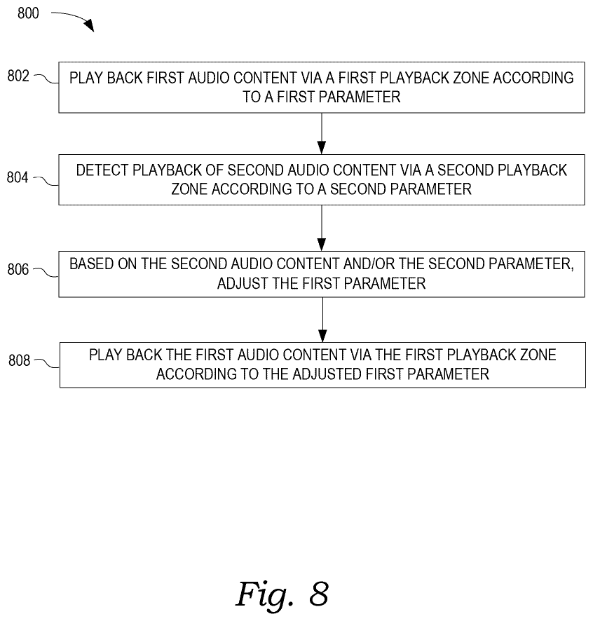

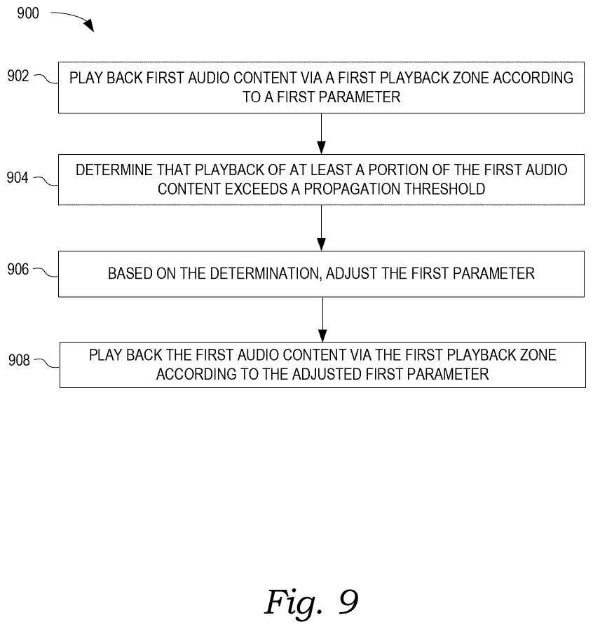

FIGS. 8 and 9 illustrate example methods in accordance with the present technology. The methods 800 and 900 can be implemented by any of the devices described herein, or any other suitable devices now known or later developed. Various embodiments of the methods 800 and 900 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods 800 and 900 and for other processes and methods disclosed herein, the flowcharts show functionality and operation of possible implementations of some embodiments. In this regard, each block may represent a component, a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that store data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 8 and 9 may represent circuitry that is wired to perform the specific logical functions in the process.

FIG. 8 illustrates an example method 800 that can be performed by a media playback system comprising at least a first playback zone and a second playback zone. In various implementations, each playback zone can include one or more playback devices. The method 800 can be used to adjust audio output in a first zone, such as playing white noise or other masking audio in a child's bedroom, to mask second audio originating from a second zone, such as home theater content from adults watching a movie.

The method 800 begins in block 802 with playing back first audio content via the first playback zone according to a first parameter. In various examples, the first audio content can be sleep-promoting audio, such as white noise, brown noise, ambient soundscapes, or other audio content designed to promote relaxation or sleep. Additionally or alternatively, the first zone may be designated in a night mode, sleep mode, isolation mode, or other setting in which psychoacoustic isolation from outside sources is desired.

In block 804, the method 800 involves detecting playback of second audio content via the second playback zone according to a second parameter. In some implementations, detecting playback of the second audio comprises detecting sound via one or more microphones positioned within the first zone. These microphones may be integrated into playback devices within the first zone or may be separate microphone devices.

The method 800 continues in block 806 with adjusting the first parameter based on the second audio content and/or the second parameter. In various examples, adjusting the first parameter comprises modifying playback of the first audio to increase a masking effect of the first audio content with respect to the second audio content for users within the first zone. This modification can involve one or more of increasing the volume of playback of the first audio content, adjusting equalization settings of playback of the first audio content, or overlaying additional masking audio, such as white noise, brown noise, or pink noise, with the first audio content.

In certain implementations, modifying playback of the first audio to increase the masking effect may involve temporarily reducing the masking effect in the presence of an audio alarm output via the first zone. This ensures that important alarm audio is not inadvertently masked and can be clearly heard by users within the first zone.

In block 808, the first audio content is played back via the first playback zone according to the adjusted first parameter. This results in the first audio content being played back in a manner that more effectively masks the second audio content originating from the second zone, providing an enhanced level of psychoacoustic isolation for users within the first zone.

The method 800 can further include detecting that playback of the second audio content via the second zone according to the second parameter has ceased and, in response, reverting playback of the first audio content via the first zone to the unadjusted first parameter. In some examples, reverting playback of the first audio content to the unadjusted first parameter can involve gradually transitioning playback of the first audio content from the adjusted first parameter to the unadjusted first parameter. This gradual transition can provide a more pleasant and less jarring listening experience for users within the first zone.

In various implementations, the method 800 can be performed continuously or periodically to dynamically adjust the playback of the first audio content in response to changes in the second audio content originating from the second zone. This allows the media playback system to adapt to the changing acoustic conditions within the environment and maintain a desired level of psychoacoustic isolation between zones.

FIG. 9 illustrates another example method 900 that can be performed by a media playback system comprising at least a first playback zone and a second playback zone. The method 900 begins in block 902 with playing back first audio content via the first playback zone according to a first parameter. In block 904, the method 900 involves determining that at least a portion of the first audio content exceeds a propagation threshold, indicating that the first audio content will propagate or has propagated beyond the first zone, or that it exceeds a volume threshold.

In various implementations, determining that playback of the first audio content exceeds the propagation threshold comprises determining that the first audio has propagated or will propagate into the second zone. This determination can be made by detecting the first audio content in the second zone via one or more microphones within the second zone or by referencing a sound-propagation model that includes the first zone and the second zone.

In some examples, the model is a first sound-propagation model, and the method 900 further comprises determining whether a door between the first zone and the second zone is open and selecting, based on determining that the door is open, the first sound propagation model. Additionally, the method 900 may involve determining whether the door is one of: (i) open, (ii) partially open, or (iii) closed. Based on determining that the door is partially open, a second sound-propagation model may be selected, and based on determining that the door is closed, a third sound-propagation model may be selected.

In certain implementations, determining whether the door is open comprises detecting, via a door sensor, that the door is not closed. Alternatively or additionally, determining the door is open may involve estimating or predicting, based on a predictive model, that the door is open based on sensor data differences between the first zone and the second zone. The predictive model can include a machine learning model, neural network, or other suitable model as described previously. The sensor data can include microphone data, temperature data, or other types of data. For example, one way to predict that the door is likely closed involves determining a temperature gradient (e.g., ˜5 degrees or higher) between the zones that exceeds a predetermined threshold.

In various examples, determining that playback of the first audio content exceeds the propagation threshold comprises determining that playback of at least a portion of the first audio content has exceeded or will exceed a frequency-based threshold volume level.

The method 900 continues in block 906 with adjusting the first parameter based on the determination made in block 904. Adjusting the first parameter may involve one or more of decreasing a playback volume of the first audio content, adjusting an equalization setting (e.g., lowering bass) for playback of the first audio content, adjusting a directionality of output for playback of the first audio content (e.g., turning off side-firing or up-firing transducers), or activating a speech-enhancement mode for playback of the first audio content.

In block 908, the first audio content is played back via the first playback zone according to the adjusted first parameter. This results in the first audio content being played back in a manner that reduces its propagation into the second zone or minimizes its impact on the acoustic environment within the second zone.

In addition to modifying audio played back via the first zone, the method 900 can also involve playing back masking audio via the second zone. This masking audio can be used to further reduce the perceived impact of the first audio content within the second zone, enhancing the psychoacoustic isolation between the zones.

In various implementations, the method 900 can be performed continuously or periodically to dynamically adjust the playback of the first audio content in response to changes in its propagation into the second zone. This allows the media playback system to adapt to the changing acoustic conditions within the environment and maintain a desired level of psychoacoustic between zones, even as doors are opened or closed, or as the content being played back in the first zone changes over time.

In the illustrated examples described above, the devices may be shown as audio and/or video playback devices. In some examples, however, one or more of the devices may comprise other types of devices including smartphones, tablets, video display devices (e.g., televisions, projectors), lanterns or flashlights, internet of things (IoT) devices such as sensors, cameras, microphones, thermostats, light sources, smart doorbells, etc.

### V. Conclusion

The above discussions relating to wireless power transfer devices, playback devices, controller devices, playback zone configurations, and media/audio content sources provide only some examples of operating environments within which functions and methods described below may be implemented. Other operating environments and configurations of wireless power transfer systems, media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

Example 1: A media playback system comprising: a first zone comprising at least a first playback device; a second zone comprising at least a second playback device; one or more processors; and data storage having instructions stored thereon that, when executed by the one or more processors, cause the media playback system to perform operations comprising: playing back first audio content via the first zone according to a first parameter; detecting playback of second audio content via the second zone according to a second parameter; based on the second audio content and/or the second parameter, adjusting the first parameter; and playing back the first audio content via the first zone according to the adjusted first parameter.

Example 2. The media playback system of any one of the preceding Examples, wherein the operations further comprise: detecting that playback of the second audio content via the second zone according to the second parameter has ceased; and reverting playback of the first audio content via the first zone according to the unadjusted first parameter.

Example 3. The media playback system of any one of the preceding Examples, wherein reverting playback of the first audio content via the first zone to the unadjusted first parameter comprises gradually transitioning playback of the first audio content from the adjusted first parameter to the unadjusted first parameter.

Example 4. The media playback system of any one of the preceding Examples, wherein detecting playback of the second audio comprises detecting sound via one or more microphones of the first zone.

Example 5. The media playback system of any one of the preceding Examples, wherein adjusting the first parameter comprises modifying playback of the first audio to increase a masking effect of the first audio content with respect to the second audio content for users within the first zone.

Example 6. The media playback system of any one of the preceding Examples, wherein modifying playback of the first audio content to increase the masking effect comprises one or more of: increasing volume of playback of the first audio content; adjusting equalization settings of playback of the first audio content; or overlaying masking audio with the first audio content (e.g., overlying white/brown/pink noise).

Example 7. The media playback system of any one of the preceding Examples, wherein modifying playback of the first audio to increase the masking effect comprises temporarily reducing the masking effect in the presence of an audio alarm output via the first zone.

Example 8. A method performed by a media playback system comprising a first zone with at least a first playback device and a second zone with at least a second playback device, the method comprising: playing back first audio content via a first zone according to a first parameter; detecting playback of second audio content via the second zone according to a second parameter; based on the second audio content and/or the second parameter, adjusting the first parameter; and playing back the first audio content via the first zone according to the adjusted first parameter.

Example 9. The method of any one of the preceding Examples, further comprising: detecting that playback of the second audio content via the second zone according to the second parameter has ceased; and reverting playback of the first audio content via the first zone according to the unadjusted first parameter.

Example 10. The method of any one of the preceding Examples, wherein reverting playback of the first audio content via the first zone to the unadjusted first parameter comprises gradually transitioning playback of the first audio content from the adjusted first parameter to the unadjusted first parameter.

Example 11. The method of any one of the preceding Examples, wherein detecting playback of the second audio comprises detecting sound via one or more microphones of the first zone.

Example 12. The method of any one of the preceding Examples, wherein adjusting the first parameter comprises modifying playback of the first audio to increase a masking effect of the first audio content with respect to the second audio content for users within the first zone.

Example 13. The method of any one of the preceding Examples, wherein modifying playback of the first audio content to increase the masking effect comprises one or more of: increasing volume of playback of the first audio content; adjusting equalization settings of playback of the first audio content; or overlaying masking audio with the first audio content (e.g., overlying white/brown/pink noise).

Example 14. The method of any one of the preceding Examples, wherein modifying playback of the first audio to increase the masking effect comprises temporarily reducing the masking effect in the presence of an audio alarm output via the first zone.

Example 15. One or more tangible, non-transitory computer-readable media storing instructions that, when executed by one or more processors of a media playback system comprising a first zone with at least a first playback device and a second zone with at least a second playback device, cause the media playback system to perform operations comprising: playing back first audio content via a first zone according to a first parameter; detecting playback of second audio content via the second zone according to a second parameter; based on the second audio content and/or the second parameter, adjusting the first parameter; and playing back the first audio content via the first zone according to the adjusted first parameter.

Example 16. The one or more computer-readable media of any one of the preceding Examples, wherein the operations further comprise: detecting that playback of the second audio content via the second zone according to the second parameter has ceased; and reverting playback of the first audio content via the first zone according to the unadjusted first parameter.

Example 17. The one or more computer-readable media of any one of the preceding Examples, wherein reverting playback of the first audio content via the first zone to the unadjusted first parameter comprises gradually transitioning playback of the first audio content from the adjusted first parameter to the unadjusted first parameter.

Example 18. The one or more computer-readable media of any one of the preceding Examples, wherein detecting playback of the second audio comprises detecting sound via one or more microphones of the first zone.

Example 19. The one or more computer-readable media of any one of the preceding Examples, wherein adjusting the first parameter comprises modifying playback of the first audio to increase a masking effect of the first audio content with respect to the second audio content for users within the first zone.

Example 20. The one or more computer-readable media of any one of the preceding Examples, wherein modifying playback of the first audio content to increase the masking effect comprises one or more of: increasing volume of playback of the first audio content; adjusting equalization settings of playback of the first audio content; or overlaying masking audio with the first audio content (e.g., overlying white/brown/pink noise).

Example 21. The one or more computer-readable media of any one of the preceding Examples, wherein modifying playback of the first audio to increase the masking effect comprises temporarily reducing the masking effect in the presence of an audio alarm output via the first zone.

Example 22. A media playback system comprising: a first zone comprising at least a first playback device; a second zone comprising at least a second playback device; one or more processors; and data storage having instructions stored thereon that, when executed by the one or more processors, cause the media playback system to perform operations comprising: playing back first audio content via the first zone according to a first parameter; determining that playback of at least a portion of the first audio content exceeds a propagation threshold; based on the determination, adjusting the first parameter; and playing back the first audio via the first zone according to the adjusted first parameter.

Example 23. The media playback system of any one of the preceding Examples, wherein the operations further comprise playing back masking audio via the second zone.

Example 24. The media playback system of any one of the preceding Examples, wherein adjusting the first parameter comprises one or more of: decreasing a playback volume of the first audio content; adjusting an equalization setting (e.g., lowering bass) for playback of the first audio content; adjusting a directionality of output for playback of the first audio content (e.g., turn off side-firing or up-firing transducers); or activating a speech-enhancement mode for playback of the first audio content.

Example 25. The media playback system of any one of the preceding Examples, wherein determining that playback of the first audio content exceeds the propagation threshold comprises determining that the first audio has propagated and/or will propagate into the second zone.

Example 26. The media playback system of any one of the preceding Examples, wherein determining that the first audio content has propagated or will propagate into the second zone comprises detecting the first audio content in the second zone via one or more microphones within the second zone.

Example 27. The media playback system of any one of the preceding Examples, wherein determining that the first audio content has propagated or will propagate into the second zone comprises referencing a sound-propagation model that includes the first zone and the second zone.

Example 28. The media playback system of any one of the preceding Examples, wherein the sound-propagation model is a first sound-propagation model, wherein the operations comprise: determining whether a door between the first zone and the second zone is open; and selecting, based on determining that the door is open, the first sound propagation model.

Example 29. The media playback system of any one of the preceding Examples, wherein determining whether the door is open comprises determining whether the door is one of: (i) open, (ii) partially open, or (iii) closed, wherein the operations comprise: selecting, based on determining that the door is partially open, a second sound-propagation model; and/or selecting, based on determining that the door is closed, a third sound-propagation model.

Example 30. The media playback system of any one of the preceding Examples, wherein determining whether the door is open comprises detecting, via a door sensor, that the door is not closed.

Example 31. The media playback system of any one of the preceding Examples, wherein determining the door is open comprises estimating/predicting, based on a predictive model, that the door is open based on sensor data differences between the first zone and the second zone.

Example 32. The media playback system of any one of the preceding Examples, wherein determining that playback of the first audio content exceeds the propagation threshold comprises determining that playback of at least a portion of the first audio content has exceeded and/or will exceed a (frequency-based) threshold volume level.

Example 33. A method performed by a media playback system comprising a first zone with at least a first playback device and a second zone with at least a second playback device, the method comprising: playing back first audio content via the first zone according to a first parameter; determining that playback of at least a portion of the first audio content exceeds a propagation threshold; based on the determination, adjusting the first parameter; and playing back the first audio via the first zone according to the adjusted first parameter.

Example 34. The method of any one of the preceding Examples, further comprising playing back masking audio via the second zone.

Example 35. The method of any one of the preceding Examples, wherein adjusting the first parameter comprises one or more of: decreasing a playback volume of the first audio content; adjusting an equalization setting (e.g., lowering bass) for playback of the first audio content; adjusting a directionality of output for playback of the first audio content (e.g., turn off side-firing or up-firing transducers); or activating a speech-enhancement mode for playback of the first audio content.

Example 36. The media playback system of any one of the preceding Examples, wherein determining that playback of the first audio content exceeds the propagation threshold comprises determining that the first audio has propagated and/or will propagate into the second zone.

Example 37. The media playback system of any one of the preceding Examples, wherein determining that the first audio content has propagated or will propagate into the second zone comprises detecting the first audio content in the second zone via one or more microphones within the second zone.

Example 38. The media playback system of any one of the preceding Examples, wherein determining that the first audio content has propagated or will propagate into the second zone comprises referencing a sound-propagation model that includes the first zone and the second zone.

Example 39. The media playback system of any one of the preceding Examples, wherein the sound-propagation model is a first sound-propagation model, wherein the operations comprise: determining whether a door between the first zone and the second zone is open; and selecting, based on determining that the door is open, the first sound propagation model.

Example 40. The media playback system of any one of the preceding Examples, wherein determining whether the door is open comprises determining whether the door is one of: (i) open, (ii) partially open, or (iii) closed, wherein the operations comprise: selecting, based on determining that the door is partially open, a second sound-propagation model; and/or selecting, based on determining that the door is closed, a third sound-propagation model.

Example 41. The media playback system of any one of the preceding Examples, wherein determining whether the door is open comprises detecting, via a door sensor, that the door is not closed.

Example 42. The media playback system of any one of the preceding Examples, wherein determining the door is open comprises estimating/predicting, based on a predictive model, that the door is open based on sensor data differences between the first zone and the second zone.

Example 43. The media playback system of any one of the preceding Examples, wherein determining that playback of the first audio content exceeds the propagation threshold comprises determining that playback of at least a portion of the first audio content has exceeded and/or will exceed a (frequency-based) threshold volume level.

Example 44. One or more tangible, non-transitory computer-readable media storing instructions that, when executed by one or more processors of a media playback system comprising a first zone with at least a first playback device and a second zone with at least a second playback device, cause the media playback system to perform operations comprising: playing back first audio content via the first zone according to a first parameter; determining that playback of at least a portion of the first audio content exceeds a propagation threshold; based on the determination, adjusting the first parameter; and playing back the first audio via the first zone according to the adjusted first parameter.

Example 45. The one or more computer-readable media of any one of the preceding Examples, wherein the operations further comprise playing back masking audio via the second zone.

Example 46. The one or more computer-readable media of any one of the preceding Examples, wherein adjusting the first parameter comprises one or more of: decreasing a playback volume of the first audio content; adjusting an equalization setting (e.g., lowering bass) for playback of the first audio content; adjusting a directionality of output for playback of the first audio content (e.g., turn off side-firing or up-firing transducers); or activating a speech-enhancement mode for playback of the first audio content.

Example 47. The one or more computer-readable media of any one of the preceding Examples, wherein determining that playback of the first audio content exceeds the propagation threshold comprises determining that the first audio has propagated and/or will propagate into the second zone.

Example 48. The one or more computer-readable media of any one of the preceding Examples, wherein determining that the first audio content has propagated or will propagate into the second zone comprises detecting the first audio content in the second zone via one or more microphones within the second zone.

Example 49. The one or more computer-readable media of any one of the preceding Examples, wherein determining that the first audio content has propagated or will propagate into the second zone comprises referencing a sound-propagation model that includes the first zone and the second zone.

Example 50. The one or more computer-readable media of any one of the preceding Examples, wherein the sound-propagation model is a first sound-propagation model, wherein the operations comprise: determining whether a door between the first zone and the second zone is open; and selecting, based on determining that the door is open, the first sound propagation model.

Example 51. The one or more computer-readable media of any one of the preceding Examples, wherein determining whether the door is open comprises determining whether the door is one of: (i) open, (ii) partially open, or (iii) closed, wherein the operations comprise: selecting, based on determining that the door is partially open, a second sound-propagation model; and/or selecting, based on determining that the door is closed, a third sound-propagation model.

Example 52. The one or more computer-readable media of any one of the preceding Examples, wherein determining whether the door is open comprises detecting, via a door sensor, that the door is not closed.

Example 53. The one or more computer-readable media of any one of the preceding Examples, wherein determining the door is open comprises estimating/predicting, based on a predictive model, that the door is open based on sensor data differences between the first zone and the second zone.

Example 54. The one or more computer-readable media of any one of the preceding Examples, wherein determining that playback of the first audio content exceeds the propagation threshold comprises determining that playback of at least a portion of the first audio content has exceeded and/or will exceed a (frequency-based) threshold volume level.

1. A media playback system comprising:
a first zone comprising at least a first playback device;
a second zone comprising at least a second playback device;
one or more processors; and
data storage having instructions stored thereon that, when executed by the one or more processors, cause the media playback system to perform operations comprising:
playing back first audio content via the first zone according to a first parameter;
detecting playback of second audio content via the second zone according to a second parameter;
determining, via a sound propagation model, an adjusted first parameter, wherein the second audio content and/or the second parameter are inputs into the sound propagation model; and
playing back the first audio content via the first zone according to the adjusted first parameter.

2. The media playback system of claim 1, wherein the operations further comprise:
detecting that playback of the second audio content via the second zone according to the second parameter has ceased; and
reverting playback of the first audio content via the first zone according to the unadjusted first parameter.

3. The media playback system of claim 2, wherein reverting playback of the first audio content via the first zone to the unadjusted first parameter comprises gradually transitioning playback of the first audio content from the adjusted first parameter to the unadjusted first parameter.

4. The media playback system of claim 1, wherein detecting playback of the second audio comprises detecting sound via one or more microphones of the first zone.

5. The media playback system of claim 1, wherein adjusting the first parameter comprises modifying playback of the first audio to increase a masking effect of the first audio content with respect to the second audio content for users within the first zone.

6. The media playback system of claim 5, wherein modifying playback of the first audio content to increase the masking effect comprises one or more of:
increasing volume of playback of the first audio content;
adjusting equalization settings of playback of the first audio content; or
overlaying masking audio with the first audio content.

7. The media playback system of claim 1, wherein modifying playback of the first audio to increase the masking effect comprises temporarily reducing the masking effect in the presence of an audio alarm output via the first zone.

8. A method performed by a media playback system comprising a first zone with at least a first playback device and a second zone with at least a second playback device, the method comprising:
playing back first audio content via a first zone according to a first parameter;
detecting playback of second audio content via the second zone according to a second parameter;
determining, via a sound propagation model, an adjusted first parameter, wherein the second audio content and/or the second parameter are inputs into the sound propagation model; and
playing back the first audio content via the first zone according to the adjusted first parameter.

9. The method of claim 8, further comprising:
detecting that playback of the second audio content via the second zone according to the second parameter has ceased; and
reverting playback of the first audio content via the first zone according to the unadjusted first parameter.

10. The method of claim 9, wherein reverting playback of the first audio content via the first zone to the unadjusted first parameter comprises gradually transitioning playback of the first audio content from the adjusted first parameter to the unadjusted first parameter.

11. The method of claim 8, wherein detecting playback of the second audio comprises detecting sound via one or more microphones of the first zone.

12. The method of claim 8, wherein adjusting the first parameter comprises modifying playback of the first audio to increase a masking effect of the first audio content with respect to the second audio content for users within the first zone.

13. The method of claim 12, wherein modifying playback of the first audio content to increase the masking effect comprises one or more of:
increasing volume of playback of the first audio content;
adjusting equalization settings of playback of the first audio content; or
overlaying masking audio with the first audio content.

14. The method of claim 8, wherein modifying playback of the first audio to increase the masking effect comprises temporarily reducing the masking effect in the presence of an audio alarm output via the first zone.

15. One or more tangible, non-transitory computer-readable media storing instructions that, when executed by one or more processors of a media playback system comprising a first zone with at least a first playback device and a second zone with at least a second playback device, cause the media playback system to perform operations comprising:
playing back first audio content via a first zone according to a first parameter;
detecting playback of second audio content via the second zone according to a second parameter;
determining, via a sound propagation model, an adjusted first parameter, wherein the second audio content and/or the second parameter are inputs into the sound propagation model; and
playing back the first audio content via the first zone according to the adjusted first parameter.

16. The one or more computer-readable media of claim 15, wherein the operations further comprise:
detecting that playback of the second audio content via the second zone according to the second parameter has ceased; and
reverting playback of the first audio content via the first zone according to the unadjusted first parameter.

17. The one or more computer-readable media of claim 16, wherein reverting playback of the first audio content via the first zone to the unadjusted first parameter comprises gradually transitioning playback of the first audio content from the adjusted first parameter to the unadjusted first parameter.

18. The one or more computer-readable media of claim 15, wherein detecting playback of the second audio comprises detecting sound via one or more microphones of the first zone.

19. The one or more computer-readable media of claim 15, wherein adjusting the first parameter comprises modifying playback of the first audio to increase a masking effect of the first audio content with respect to the second audio content for users within the first zone.

20. The one or more computer-readable media of claim 19, wherein modifying playback of the first audio content to increase the masking effect comprises one or more of:
increasing volume of playback of the first audio content;
adjusting equalization settings of playback of the first audio content; or
overlaying masking audio with the first audio content.
